(19) United States
(12) Patent Application Publication
(10) Pub. No.: US 2021/0249769 A1
(43) Pub. Date: Aug. 12, 2021

(54) ANTENNA ARRAY SYSTEM FOR MONITORING VITAL SIGNS OF PEOPLE

(71) Applicant: IEE INTERNATIONAL ELECTRONICS & ENGINEERING S.A., ECHTERNACH (LU)

(72) Inventor: Andreas DIEWALD, Kell am See (DE)

(21) Appl. No.: 16/973,350

(22) PCT Filed: Jun. 12, 2019
(86) PCT No.: PCT/EP2019/065386

§ 371 Date: Dec. 8, 2020

(30) Foreign Application Priority Data
Jun. 12, 2018 (LU) LU100837

(51) Int. Cl. H01Q 3/36; H01Q 3/28; H01Q 9/04; H01Q 1/00; H01Q 3/02; G01S 7/02; G01S 7/03; G01S 13/88

(52) U.S. Cl. CPC H01Q 3/36; H01Q 3/28; H01Q 9/045; G01S 13/88; H01Q 3/02; G01S 7/023; G01S 7/03; H01Q 1/007

(57) ABSTRACT

A patch antenna array system for monitoring vital signs of people in a closed environment, the patch antenna array system including three patches, the farfield pattern of which is shaped in the E-plane by series-feeding and in the H-plane by parallel-feeding to attain a heart-shaped pattern compensating free-space losses due to larger distances.

### TECHNICAL FIELD

The present invention generally relates to a radar antenna array system adapted for monitoring vital signs of people in closed environments, e.g. people in their home or inside of vehicles or the like.

### BACKGROUND

Because of the rising amount of elderly people in retirement homes and the non-continuous observation by caretakers, the early recognition of emergency cases becomes more important. To ensure a normal everyday life for these people a conventional vital sign monitor can't be used. Microwave technology turned out to be an effective alternative for such vital sign monitor. There are many activities in microwave-based vital sign monitoring in the last decade as active radar MMICs become less expensive. Radar is the preferable technology for vital sign monitoring because microwaves are invisible and can penetrate through dry clothing and walls. Many activities are based on standard radar systems (classical CW or FMCW systems) with conventional antenna designs and by optimizing the signal processing as for instance disclosed by C. Will, K. Shi, F. Lurz, R. Weigel and A. Koelpin, “Intelligent signal processing routine for instantaneous heart rate detection using a Six-Port microwave interferometer,” 2015 International Symposium on Intelligent Signal Processing and Communication Systems (ISPACS), Nusa Dua, 2015, pp. 483-487. An overview of radar activities is given by C. Will et al., “Local Pulse Wave Detection using Continuous Wave Radar Systems,” IEEE Journal of Electromagnetics, RF and Microwaves in Medicine and Biology, vol. PP, no. 99, pp. 1-1.

For interior radar applications radar systems are adapted to be mounted on the ceiling of a room. Since room geometries are mostly cubical the distance from the radar sensor to the room corners is between sqrt(2) or even sqrt(3) times longer than to objects directly below the sensor.

Planar antennas (e.g. patch antennas) used for interior radar applications are problematic as having a limited opening angle, mostly +−30° at −3 dB (+−6-7 dB at +−45°) for patch antenna embodiments. This means that humans present in the corner of a room or in a bed directly located at the walls appear in the radar sensor processing with much lower power than humans present directly below the sensor. This situation shall be described in more detail based on the following example: A typical room has a height of 3 m and a width and length of 6 m. The corners are found under an angle of +−45° measured from the normal of the radar sensor. Due to antenna characteristic in the TX and the RX case the power drop is −15 dB. Due to the power drop of 4-5 dB caused by free space attenuation the overall power drop is 20 dB. It could be up to 30 dB when people are located in the corner of the room.

Therefore, there is a need for an improved radar antenna array system allowing for a radar sensor processing based at least essentially on the same power independent of peoples being present in room corners, being present directly below the radar sensor or moving around in the room. In other words, there is a need for a radar antenna array system which can reliably monitor people's vital signs while they are present at any part of their home as well as while they move freely around in their home.

### SUMMARY

It is therefore desirable to provide a radar antenna array system which can monitor people's vital signs while they are present at any part of their home as well as while they move freely around in their home.

This object may be attained by the features of claim 1. Advantageous developments of the invention are defined by the sub claims.

In order to solve the above mentioned problem, the present invention provides for a radar antenna array system for monitoring vital signs of people present in a closed environment, such as a room or a vehicle, the system comprising three patches, the farfield pattern of which is shaped in the E-plane by series-feeding and in the H-plane by parallel-feeding to attain a heart-shaped pattern compensating free-space losses due to larger distances of the people from the system. The radar antenna array system comprising at least one of:
an array of three-by-one patches configured to shape the farfield pattern in the E-plane by series-feeding or parallel-feeding,
an array of one-by-three patches configured to shape the farfield pattern in the H-plane by parallel-feeding or series-feeding, or
an array of three-by-three patches configured to shape the farfield pattern in the E- and the H-plane by parallel-feeding and/or series-feeding,
wherein the configuration is such that the resulting antenna pattern comprises two or more maxima in order to enhance the radiation into certain areas of said closed environment such as edge areas or the corner areas of said closed environment. It will be noted that the resulting antenna pattern will also have one or more minima in order to minimize the radiation into other areas e.g. in the middle of the room in the vicinity of the mounting location of the antenna array system.

The inventors have endeavored to optimize the technological prerequisite of radar antenna arrays in such a way that the subsequent signal processing benefits from a specially improved antenna beam pattern with 2 TX and 4 RX-channels to illuminate rooms to be monitored perfectly with respect to people present therein. The radar antenna array system described herein may be installed in the center of a room's ceiling in for instance a retirement home. The radar system may take the form of a dedicated microstrip patch antenna array the farfield pattern of which is shaped in the E-plane by series-feeding and in the H-plane by parallel-feeding to attain a heart-shaped pattern allows for compensation of the radiation power in certain directions of the room, as for instance the room's corners. Preferably the antenna system is realized as microstrip patch antenna based on a series fed line array of three individual patch antennas.

In an embodiment the E-plane shaping is done be series-feeding and the H-plane shaping is done be parallel feeding. Nevertheless the shaping in the E-plane and/or the H-plane can be done by series-feeding and/or parallel-feeding. Thus the heart-shaped pattern is in both planes, the series-feeding is shaping the heart-shaped pattern in the H-plane and the parallel feeding is shaping the heart-shaped pattern in the E-plane. As both feedings are orthogonal to each other the overall shape is a multiplication of both shapes.

More particularly, in a preferred embodiment of the invention, the parallel fed patches for shaping the farfield pattern in the H-plane are specified as follows:

| Patch i | Amplitude Aᵢ | Phase [degree] | x-Position [mm] |
|---|---|---|---|
| Patch 1 | 1 | 0 | −6.213 |
| Patch 2 | 2 | 175 | 0 |
| Patch 3 | 1 | 0 | 6.213 |

and the series fed patches for shaping the farfield pattern in the E-plane are specified as follows:

| Patch i | Amplitude Aᵢ | Phase [degree] | y-Position [mm] |
|---|---|---|---|
| Patch 1 | 1 | 0 | 12.426 |
| Patch 2 | 2 | 165 | 6.213 |
| Patch 3 | 1 | 0 | 0 |

Still more particularly, the arrays for E- and H-plane shaping of the farfield pattern are preferably combined into a 3×3 array containing 9 microstrip patch antennas, the resulting farfield pattern, the amplitude and phase shift between each of these patches are specified as follows:
a) patch amplitudes as a function of position

| Y [mm] | X [mm] | −6.213 | 0 | 6.213 |
|---|---|---|---|---|
| 12.426 | | 0.2 | 0.4 | 0.2 |
| 6.213 | | 0.4 | 0.8 | 0.4 |
| 0 | | 0.2 | 0.4 | 0.2 |

b) patch phases as a function of position

| Y [mm] | X [mm] | −6.213 | 0 | 6.213 |
|---|---|---|---|---|
| 12.426 | | 165° | 340° | 165° |
| 6.213 | | 0° | 175° | 0° |
| 0 | | −165° | 10° | −165° |

It should be noted that the 3×3 array may be a parallel-fed array of three single series-fed 3×1 antennas. It could also be implemented by a series-fed array of three single parallel-fed 1×3 antennas.

Advantageously, the spacing between the patches is λ/2=6.213 mm, the length of the patches is around Lₚ=3.167 to 3.4 mm, with different patch lengths, variable spacings appearing between the patches, wherein a space of 2.838 mm exists between patch 2 and patch 3 and of 2.971 mm between patch 1 and patch 2 which space is used for phase adjustment of the patches.

In a preferred embodiment, the space between patch 2 and patch 3 is adjusted in order to reduce the interference of the feeding with the patch reflection.

It should be noted that the radar antenna array system of the invention is not limited to monitoring vital signs of people present in their home, but generally for surveillance tasks in closed environments as for instance in vehicles of all kind, particularly bigger cars having a larger cargo space or passenger compartment.

### BRIEF DESCRIPTION OF THE DRAWINGS

Further details and advantages of the present invention will be apparent from the following detailed description of not limiting embodiments with reference to the attached drawing, wherein:

FIG. 1 shows a schematic of an assumed room in a retirement home;

FIG. 2 shows a single-port microstrip patch antenna with reflection S₁₁;

FIG. 3 shows an H- and E-plane simulation standard patch antenna;

FIG. 4 shows a characteristic pattern of serial and parallel fed arrays of the antenna of FIG. 3;

FIG. 5 shows an H-plane standard patch, farfield array of the antenna array system of an embodiment of the invention;

FIG. 6 shows an E-plane standard patch, farfield array of the antenna array system of an embodiment of the invention;

FIG. 7 shows the total antenna 3D farfield, simulation farfield array of the antenna array system of an embodiment of the invention;

FIG. 8 shows a second and third patch of the antenna array system;

FIG. 9 shows a shifted reference plane of a lower patch relative to a subsequent patch;

FIG. 10 shows the second and third patch of the antenna array system with feeding lines;

FIG. 11 shows a simulation of S₂₁ for the middle patch (i=2) of the antenna array system;

FIG. 12 shows a simulation of S₂₁ for the third patch (i=3) of the antenna array system;

FIG. 13 shows a simulation of the farfield in the E-plane for completed antenna array system;

FIG. 14 shows a simulation of S₁₁ completed antenna array system;

FIG. 15 shows a simulation of the farfield in the E-plane for completed antenna array system; and

FIG. 16 shows a simulation of the 3D farfield completed Line Array antenna array system.

### DESCRIPTION OF PREFERRED EMBODIMENTS

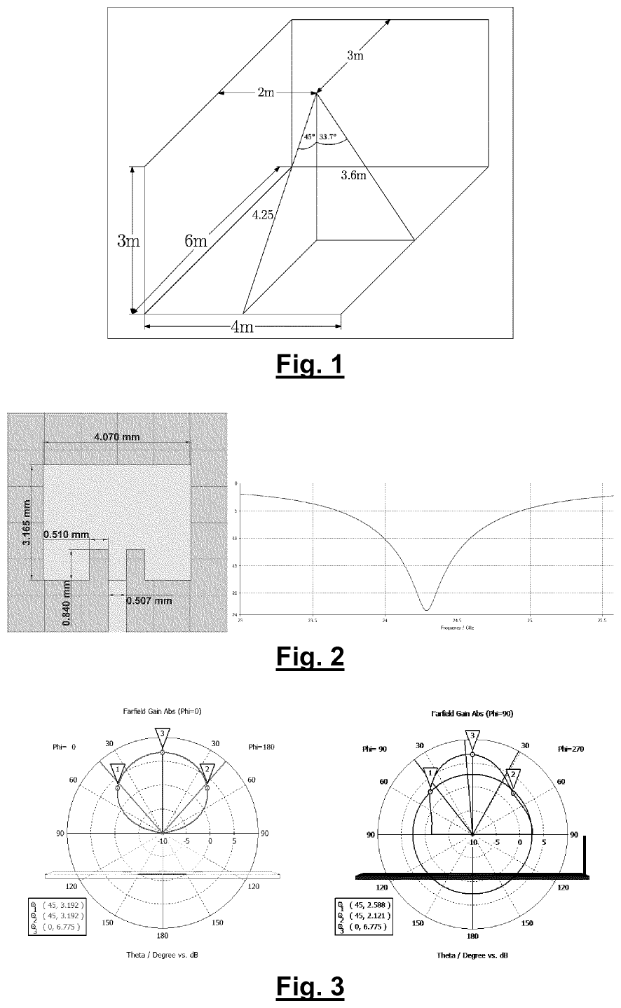

In FIG. 1 the schematic of an assumed room in a retirement home is shown. The average room size in retirement homes is assumed to be 3 meters in height, 6 meters in length and 4 meters in width. In order to monitor the complete floor area in one direction, a triangle with a base of 6 meters and the height of 3 meters is assumed. In the other direction a triangle with a base of 4 meters is assumed for the radiation pattern. As the sensor will be installed in the middle of the ceiling the triangles are symmetric. Thus, an opening angle for one antenna would be ±45° and for the other ±33.7°. The distance from sensor to the floor right below (direction defined as φ=0° and θ=0°) is 3 m, from sensor to the floor-wall corner (φ=0° and θ=±45°) is 4.25 m and to the other floor-wall corner (φ=90° and θ=±33.7°) is 3.6 m.

An analysis of the radar equation

$${P}_{r} = {P}_{t} \cdot \frac{{G}_{T X} \cdot {G}_{R X} \cdot {λ}^{2} \cdot σ}{{( 4 π )}^{3} \cdot {R}^{4}} \qquad ( 1 )$$

shows that for targets with constant radar target cross section a the received power at a radar with isotropic radiation (G_{TX}=G_{RX}=1∀θ,φ) is factor ¼ lower when located in the 45° corner instead of to be located directly below the sensor. For an angle of 33.7° corner the radiation is about ½ lower. Normally patch antennas radiate their maximum power into broadside direction (φ=0° and θ=0°) thus the receive power of targets below the sensor is much higher compared to targets in the corner.

The free-space loss due to higher distance at θ=±33.7° is 4 dB, the power reduction of a standard patch antenna under θ=±33.7° for the transmit antenna is approx. 3-4 dB. Thus this antenna needs to have a 8 dB higher gain into φ=90°, θ=±33.7° compared to broadside direction.

Pᵣ(φ=90°,θ=33.7°)=Pᵣ(φ=0°,θ=0°)+8 dB (2)

The second antenna needs to realize a 10 dB higher gain into φ=0°, θ=±45°:

Pᵣ(φ=0°,θ=45°)=Pᵣ(φ=0°,θ=0°)+10 dB (3)

The modeling of the proposed antenna and network are simulated with CST MICROWAVE STUDIO (S. Müller, R. Thull, M. Huber and A. R. Diewald, “Analysis on microstrip transmission line surface coatings”, 2016 Loughborough Antennas & Propagation Conference (LAPC), Loughborough, 2016, pp. 1-4) in the K-band in the frequency domain of 24 GHz to 24.25 GHz. The antenna design is done for a permittivity of 3.66 which is given in the datasheet of ROGERS and for a permittivity of 3.72 which could be taken from a measurement graph in the datasheet.

Standard Patch Antenna

To achieve the radiation pattern in both directions, the radiation power and phase shift of each patch antenna need to be determined. In use of a standard microstrip patch antenna and the CST MICROWAVE tool Farfield Array the desired radiation pattern can be simulated. That happens by interfering the farfield of the standard patch three times with a space shifting of λ/2. For all three patches radiation power and phase shifts can be individually adjusted.

The standard patch and the return loss is shown in the FIG. 2.

The return loss values in the whole frequency domain are never more than −10 dB. The farfield is split in E- and H-Plane which results from the view of angle. Thus, the H-Plane describes the front view across the feeding (φ=0°,θ=±π°) and the E-Plane describes the side view (φ=90°,θ=±π°). Both are shown in FIG. 3.

The H-Plane shows a symmetrical radiation. Based on this radiation the desired farfield pattern resulting from the equation (3) is achieved. The E-Plane is unsymmetrical, which is based on the one-sided patch feeding, though the main lobe angle can, by use of the radiation power and phase shift, be partly compensated.

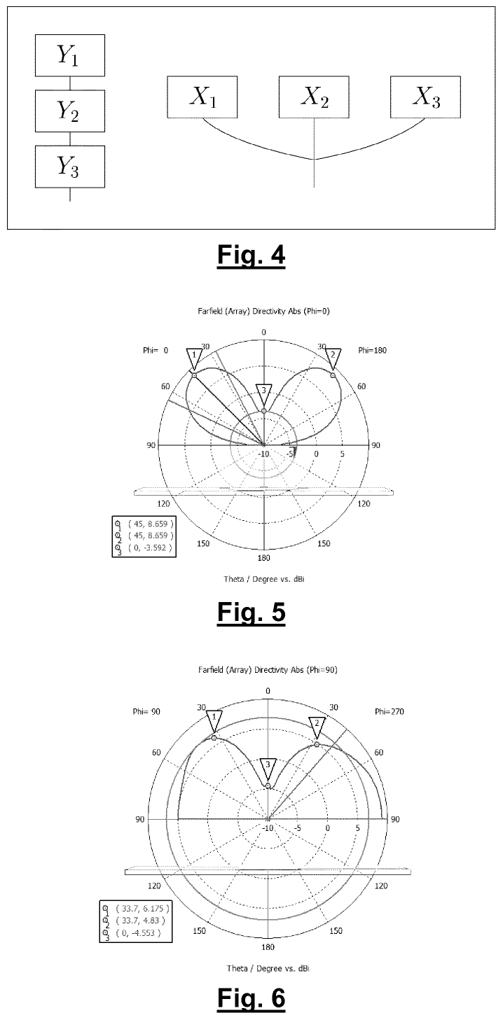

In the later build line array this patch will be used as patch Y₁, see FIG. 4. Thus the second and third patch need to be created. Also, this patch will be used as transmitting patch in all three patches of the parallel fed array. The characteristic pattern of both, series and parallel fed arrays are shown below.

H-Plane Shaping

Due to the symmetrical radiation of the standard patch H-Plane, a cardioid radiation pattern results according to the equation 3. In use of the farfield tool with adjusting the amplitude and phase shift of three patches, the farfield pattern of FIG. 5 shows promising results with a gain difference of 12 dB.

The specifications for the parallel fed patches are shown in the table 3.1.

TABLE 3.1
Specifications H-Plane

| Patch i | Amplitude Aᵢ | Phase [degree] | x-Position [mm] |
|---|---|---|---|
| Patch 1 | 1 | 0 | −6.213 |
| Patch 2 | 2 | 175 | 0 |
| Patch 3 | 1 | 0 | 6.213 |

E-Plane Shaping

In the E-Plane, these specifications can be transferred. Here a gain difference of 8 dB need to be accomplished. Slightly adjusted, the radiation pattern results in FIG. 6, which shows a gain difference of 10 dB in the direction of (φ=90°,θ=33.7°) and a difference of 9 dB in (φ=90°,θ=−33.7°).

These gain differences according to equation 2 are up to 3 dB higher which results by reason of the squinting in equation 3. However this is still a sufficient good result, since the main point of a higher gain in certain directions is achieved. The table 3.2 shows the resulting parameters for the series fed patch array.

TABLE 3.2
Specifications E-Plane

| Patch i | Amplitude Aᵢ | Phase [degree] | y-Position [mm] |
|---|---|---|---|
| Patch 1 | 1 | 0 | 12.426 |
| Patch 2 | 2 | 165 | 6.213 |
| Patch 3 | 1 | 0 | 0 |

Complete Array

If these arrays for E- and H-Plane are combined, a 3×3 array results which contains 9 microstrip patch antennas. To show the resulting farfield pattern, the amplitude and phase shift between each of these patches need to be determined. The tables 3.3 and 3.4 are showing these.

TABLE 3.3
Patch Amplitudes according to Position

| Y [mm] | X [mm] | −6.213 | 0 | 6.213 |
|---|---|---|---|---|
| 12.426 | | 0.2 | 0.4 | 0.2 |
| 6.213 | | 0.4 | 0.8 | 0.4 |
| 0 | | 0.2 | 0.4 | 0.2 |

TABLE 3.4
Patch Phases according to Position

| Y [mm] | X [mm] | −6.213 | 0 | 6.213 |
|---|---|---|---|---|
| 12.426 | | 165° | 340° | 165° |
| 6.213 | | 0° | 175° | 0° |
| 0 | | −165° | 10° | −165° |

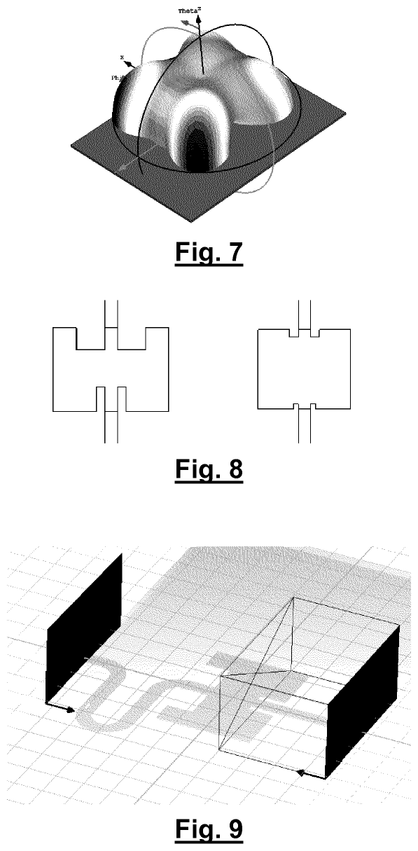

These values inserted in the Farfield Array result in a 3D pattern with a higher radiation in the corners as shown in FIG. 7.

Series Fed Line Array, H-Plane

To achieve the radiation pattern according to equation 2, a series fed patch array of three microstrip patch antennas is used. Each single patch is designed for low reflection with Γ≈0 at the feeding port (port 1). In the following the balance between radiated power and transmitted power to port 2 is adjusted. The last patch (i=1) with power absorption of 100% is already finished. The amplitude of the middle patch (i=2) is twice the amplitude of the last patch which yields a four times higher power. Thus, the second patch needs to accept the power which is radiated by itself and the power which is transmitted to the last antenna. The following table 4.1 shows the transmission coefficients adapted to the given amplitudes. The phase shift between the patches will be adjusted later by conventional delay lines.

TABLE 4.1
S21 of Each Single Patch

| Antenna | Radiation Power | S21 [db] | S21 [lin.] |
|---|---|---|---|
| Patch 1 | 0.166 | none | none |
| Patch 2 | 0.666 | −7.99 | 0.447 |
| Patch 3 | 0.166 | −0.79 | 0.912 |

Patch Design, Transmission Adjustment

The adjustment of the recess length l₁, at the input port has the most effect on the input reflection. The patch width lₚ but also the recess width l₂ and recess width w₂ at the output port are influencing the transmission coefficient S₂₁. Thus, the reflection and the transmission can mostly be controlled independently. First the single patches are created as shown in FIG. 8.

Feeding Design, Phase Adjustment

The spacing between the patches is λ/2 which equals 6.213 mm. The length of the patches is around Lₚ=3.167 up to 3.4 mm. Due to the different patch lengths variable spacings appears between the patches. There is a space of 2.838 mm between patch 2 to patch 3 and of 2.971 mm between patch 1 to patch 2. This space is used for phase adjustment of the several patches. The phase difference corresponding to the specification in table 3.2 is defined from the reference plane of the lower patch which is the patch edge at the ending of the recess to the comparable reference planes of the subsequent patches, shown in FIG. 9. The feeding microstrip lines are designed as short as possible in order to reduce the losses.

The design of the resulting feeding lines is shown in FIG. 10. Compared to FIG. 8 the recess of the third patch is further adjusted. This occurs by reason of the feeding which interferes with the patch reflection.

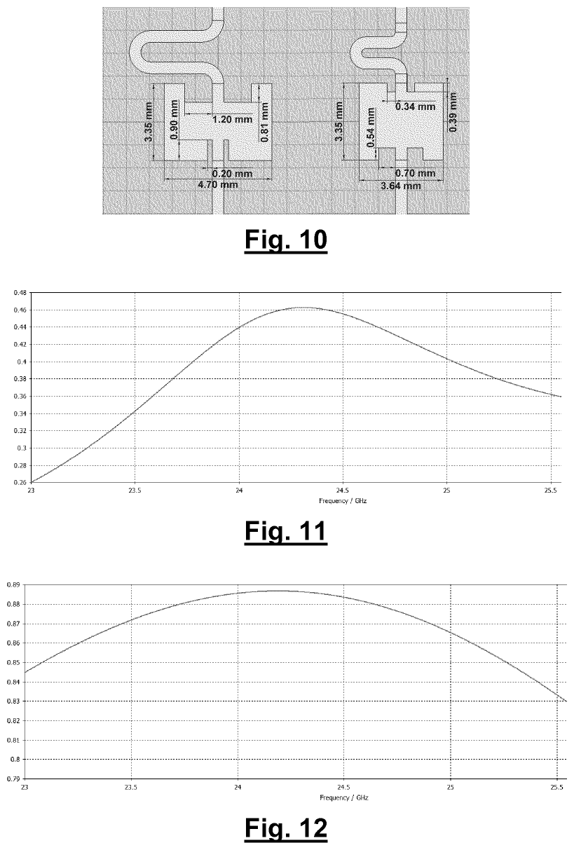

As shown in FIG. 11 the transmissions of both patches depart less than 3% from the specifications of table 4.1. This is a good result, since the transmission loss of the signal lines were not considered in the farfield array tool.

As shown in FIG. 12 in the third patch a transmission of S21=0.89 and the middle patch of S21=0.46 are achieved which are close to the specifications of 4.1.

Simulation Line Array

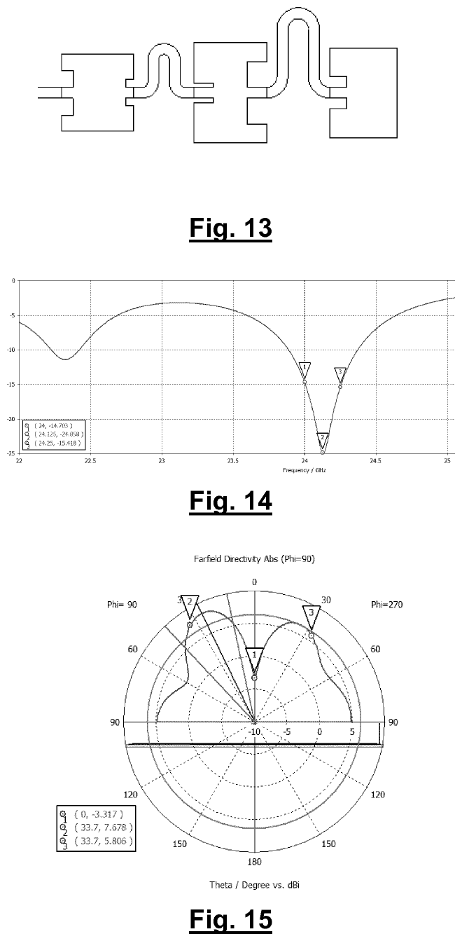

In FIG. 13 the completed one-dimensional antenna Line Array (LA) is shown which results from the connection of FIG. 2 and FIG. 10.

The total antenna length is l=15.694 mm and the maximum width is w=6.339 mm. In FIG. 14 the antenna reflection coefficient is shown by simulation. A reflection of less than −15 dB is obtained in the 24 GHz ISM band and the minimal reflection of −24.85 dB is reached at the center frequency of 24.125 GHz.

The farfield in the E-plane yields a satisfying pattern with a gain difference of more than 8 dB at θ=0° compared to θ=33.7° which is shown in FIG. 15. Due to the microstrip feeding between the single patches and the antenna feeding from the right, the radiation pattern is squinted. Thus, a symmetric farfield of the Line Array is not achieved.

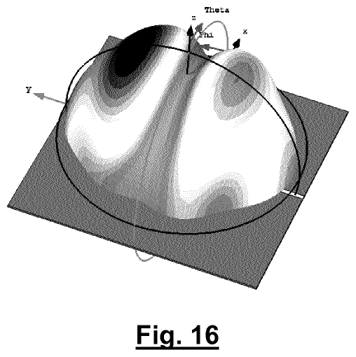

The total 3D antenna farfield pattern is shown in FIG. 16.

1. A radar antenna array system for monitoring vital signs of people in a closed environment, the system comprising at least one of:
an array of three-by-one patches configured to shape the farfield pattern in the E-plane by series-feeding or parallel-feeding,
an array of one-by-three patches configured to shape the farfield pattern in the H-plane by parallel-feeding or series-feeding, or
an array of three-by-three patches configured to shape the farfield pattern in the E- and the H-plane by parallel-feeding and/or series-feeding,
the configuration being such that the resulting antenna pattern comprises two or more maxima in order to enhance the radiation into certain areas of said closed environment such as edge areas or the corner areas of said closed environment.

2. The system of claim 1, wherein the parallel fed patches for shaping the farfield pattern in the H-plane are specified as follows:

| Patch i | Amplitude Aᵢ | Phase [degree] | x-Position [mm] |
|---|---|---|---|
| Patch 1 | 1 | 0 | −6.213 |
| Patch 2 | 2 | 175 | 0 |
| Patch 3 | 1 | 0 | 6.213 |

and/or wherein the series fed patches for shaping the farfield pattern in the E-plane are specified as follows:

| Patch i | Amplitude Aᵢ | Phase [degree] | y-Position [mm] |
|---|---|---|---|
| Patch 1 | 1 | 0 | 12.426 |
| Patch 2 | 2 | 165 | 6.213 |
| Patch 3 | 1 | 0 | 0. |

3. The system of claim 2, wherein the arrays for E- and the H-plane shaping of the farfield pattern are combined into a 3×3 array containing 9 microstrip patch antennas, the resulting farfield pattern, the amplitude and phase shift between each of these patches are specified as follows:
a) patch amplitudes as a function of position

| Y [mm] | X [mm] | −6.213 | 0 | 6.213 |
|---|---|---|---|---|
| 12.426 | | 0.2 | 0.4 | 0.2 |
| 6.213 | | 0.4 | 0.8 | 0.4 |
| 0 | | 0.2 | 0.4 | 0.2 |

b) patch phases as a function of position

| Y [mm] | X [mm] | −6.213 | 0 | 6.213 |
|---|---|---|---|---|
| 12.426 | | 165° | 340° | 165° |
| 6.213 | | 0° | 175° | 0° |
| 0 | | −165° | 10° | −165°. |

4. The system of claim 1, wherein the transmission coefficients of a series fed patch array of three patches adapted to the given amplitudes are specified as follows (S21 of each single patch):

| Antenna | Radiation Power | S21 [db] | S21 [lin.] |
|---|---|---|---|
| Patch 1 | 0.166 | none | none |
| Patch 2 | 0.666 | −7.99 | 0.447 |
| Patch 3 | 0.166 | −0.79 | 0.912 |

wherein the phase shift between the patches is adjusted by delay lines.

5. The system of claim 4, wherein the spacing between the patches is λ/2=6.213 mm, the length of the patches is around Lₚ=3.167 to 3.4 mm, with different patch lengths, variable spacings appearing between the patches, wherein a space of 2.838 mm exists between patch 2 and patch 3 and of 2.971 mm between patch 1 and patch 2 which space is used for phase adjustment of the patches.

6. The system of claim 5, wherein the space between patch 2 and patch 3 is adjusted in order to reduce the interference of the feeding with the patch reflection.
